(19) United States
(12) Patent Application Publication
(10) Pub. No.: US 2003/0002476 A1
(43) Pub. Date: Jan. 2, 2003

(54) Integrated internet phone call routing system

(76) Inventors: David W. Chung, San Pedro, CA (US); Jong Guon Lee, Seoul (KR); Sae Joon Kim, Pico Rivera, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/752,413

(22) Filed: Dec. 28, 2000

(30) Foreign Application Priority Data
Dec. 29, 1999 (KR) F19C021

(51) Int. Cl. H04L 12/66

(52) U.S. Cl. 370/352; 370/356

(57) ABSTRACT

One embodiment of the present invention is a gateway call routing system used to route calls, wherein the gateway connects a PSTN and the Internet. The call routing system includes a first computer connection module for connecting to a computer terminal, such as an Internet voice terminal, of a calling party, and a first phone connection module for connecting to a phone terminal of the calling party. In addition, the call routing system includes a second computer connection module for connecting to a computer terminal of a called party, and a second phone connection module for connecting to a phone terminal of the called party. Further, the call routing system includes a voice tuning module which sets voice tuning to a phone-to-phone mode if the terminal of the calling party is a phone and the terminal of the called party is also a phone, to a computer-to-phone mode if the terminal of the calling party is a computer and the terminal of the called party is a phone, to a phone-to-computer mode if the terminal of the calling party is a phone and the terminal of the called party is a computer, and to a computer-to-computer mode if the terminal of the calling party is a computer and the terminal of the called party is also a computer.

### RELATED APPLICATIONS

This application claims the benefit under 35 U.S.C. §119(a) of Korean Patent Application No. F19C021, filed Dec. 29, 1999.

### BACKGROUND OF THE INVENTION

1. Field of Invention

The present invention relates to a call routing system, and in particular to methods and systems for a call routing system used to route calls over a network.

2. Description of the Related Art

Voice data has traditionally been transferred over a circuit-switched network, such as the Public Switched Telephone Network (PSTN), including what is often referred to as “plain old telephone service” (POTS). These traditional networks have typically been optimized for real-time or synchronous voice communication. In a conventional circuit-switched network, when a telephone call is established, a circuit is dedicated between the parties of telephone conversation and remains dedicated until the call ends. While dedicating a circuit for each call helps ensure a high degree of call quality, the network bandwidth use remains constant for each call in such a network, thus increasing overall bandwidth requirements and costs.

More recently, Internet protocol (IP) telephony, which uses the Internet to send voice and other data between two parties, has come into use. The Internet is a packet-based network that transmits information in packet form. For example, to transmit voice calls over the Internet, analog voice data is digitized and formatted into packets, each packet containing a destination address and a sequence number. The packets are routed by various components such as gateways, routers, and servers to the designated recipient. Once the packets reach the recipient, the packets are decoded into their original order using the sequence number in each packet. Because IP telephony uses packets to transfer voice rather than dedicating a circuit, bandwidth use is more efficient. The increased efficiency and the resulting cost savings has contributed to the increased utilization of Voice over Internet Protocol (VoIP) and Fax over Internet Protocol (FoIP).

While VoIP has become popular as a result of the cost savings, VoIP systems still need to be able to make the connections between the existing traditional voice transmission systems and the newer packet-based devices. Gateways serve as an important component in bringing the IP telephony into the conventional voice systems by bridging the traditional circuit-switched telephony world with the Internet and related packet-based devices. Gateways make it possible for the standard telephone to take advantages of IP telephony by performing the necessary tasks such as digitizing the standard telephone signal, optionally compressing it, packetizing the signal for compatibility with the Internet and then routing the packets to a destination over the Internet.

In general, IP telephony service can be classified into at least four cases: computer-to-computer, computer-to-phone, phone-to-computer and phone-to-phone. In the computer-to-computer case, two users may communicate with each other utilizing multi-media Internet connected computers, such as H.323 compliant personal computers (PCs). These computers may be connected to a local access network (LAN) or may be connected via a modem to a telephone line and, using an Internet service provider (ISP), access the Internet. In transmitting voice signals, the originating party's computer's codec and software perform sampling, compression and packetization of audio signals, and the received audio signals are reproduced using a sound card in the receiving party's computer.

In the computer-to-phone case, a computer is connected to a gateway via the PSTN to provide a phone number of a called party. The gateway interprets the phone number to connect the computer to the called party's conventional phone unit, that is, a phone unit intended to be used with a conventional circuit-switched telephony system rather than a packetized system, through the existing PSTN.

In the phone-to-computer case, a subscriber of an existing PSTN connects to a gateway and provides the called party's calling information to the gateway. Then, the gateway connects to the called computer via the Internet to complete the connection.

FIG. 1 illustrates conventional communication between two telephones in the phone-to-phone case using the Internet. Referring to FIG. 1, a first telephone 102 is connected to the Internet 110 via a first PSTN 106 and a first Internet phone gateway 108. A second phone 116 is connected to the Internet 110 via a second PSTN 114 and a second Internet phone gateway 112.

In the above-described configuration, in order to connect the first phone 102 and the second phone 116, the first Internet phone gateway 108 is first connected with the first phone 102 via the first PSTN 106. The first Internet phone gateway 108 identifies a calling party for user authentication and billing purposes and receives the phone number of a called party. The first Internet phone gateway 108 packetizes the called party's phone number and sends the packet(s) over the Internet 110 to the second Internet phone gateway 112, which is in closer geographical proximity to the called party. The second Internet phone gateway 112 extracts the called party's phone number from the packets(s) and places a call to the called party via the second PSTN 114 to establish the connection.

Once the connection between two telephone users is established, voice data is coded in the first Internet phone gateway 108 and transmitted via the Internet 110 to the second Internet phone gateway 112. The voice data is received, decoded, and the voice signal reproduced by the second Internet phone gateway 112 and sent to the second PSTN 114 which forwards it to the second phone 116.

Likewise, the voice data from the called party's phone 116 is coded in the second Internet phone gateway 112 and transmitted via the Internet 110 to the first Internet phone gateway 108. The voice data is received, decoded, and the voice signal reproduced by the first Internet phone gateway 108 and sent to the first PSTN 106 which forwards it to the first phone 102.

However, as described above, because conventionally call routing techniques and voice tuning methods are different for each of the above four call routing cases, four correspondingly different types of call routing systems are conventionally used to perform call processing, thereby increasing system cost and maintenance. Further, conventional voice tuning methods typically use a hardware solution for the phone-to-phone case and a software solution for the computer-to-computer case. Attempts to perform voice tuning for cases including both the phone and the computer have often been unsuccessful, as the voice quality has not been adequately maintained.

### SUMMARY OF THE INVENTION

The present invention is directed to systems and methods for providing an integrated call routing system capable of providing voice tuning for phone-to-phone, phone-to-computer, computer-to-phone, and computer-to-computer voice calls.

In one embodiment, an integrated Internet Phone call routing system, including a PC Connection Module, a Phone Connection Module, and a Voice Tuning Module, is provided. The PC Connection Module provides for connections to personal computers (PCs), or other computer terminals, and the Phone Connection Module provides for connections to conventional phone terminals. The Voice Tuning Module selectively provides the appropriate voice tuning depending on the type of connection case. In particular, the Voice Tuning Module performs voice tuning by adjusting various related parameters, including echo, delay, and jitter buffer according to the connection case. The Internet Phone call routing System determines which connection case is operative by examining the mode of the calling terminal and the mode of the called terminal. These two modes determine the connection case.

In another embodiment of the present invention, an integrated call routing system is used to perform voice tuning on calls. The integrated call routing system includes a first PC connection module used to receive calls placed using an Internet voice terminal, such as an H.323 or SIP compliant terminal and the like, and a first phone connection module used to receive calls placed by a phone unit. The phone unit is a traditional phone intended to be used with telephony systems that provide dedicated circuits for calls. The integrated call routing system further includes at least a first voice tuning module configured to automatically perform a first type of voice tuning for calls received by the first PC connection module whose destination information includes a phone number. The voice-tuning module is further configured to automatically perform a second type of voice tuning for calls received by the first PC connection module whose destination information includes an IP address. In addition, the voice tuning module is also configured to automatically perform a third type of voice tuning for calls received by the first phone connection module whose destination information includes a phone number. The voice tuning module is additionally configured to automatically perform a fourth type of voice tuning for calls received by the first phone connection module whose destination information includes an IP address.

In still another embodiment, the present invention provides a process for performing voice tuning for calls placed over a telephony network. Call information for a call from a first terminal is received. The call information includes destination information. The terminal-type of the first terminal is determined. The destination information is examined to determine if the destination terminal is a phone or an H.323 or other computer voice terminal. The process performs computer-to-computer voice tuning for the call at least partly in response to determining that the first terminal is an H.323 or other computer voice terminal and that the destination terminal is an H.323 or other computer voice terminal. The process performs phone-to-computer voice tuning for the call at least partly in response to determining that the first terminal is a phone and that the destination terminal is an H.323 or other computer voice terminal. The process performs computer-to-phone voice tuning for the call at least partly in response to determining that the first terminal is an H.323 or other computer voice terminal and that the destination terminal is a phone. The process performs phone-to-phone voice tuning for the call at least partly in response to determining that the first terminal is a phone and that the destination terminal is a phone.

### BRIEF DESCRIPTION OF THE DRAWINGS

These and other features of the invention will now be described with reference to the drawings summarized below. These drawings and the associated description are provided to illustrate example embodiments of the invention, and not to limit the scope of the invention.

FIG. 1 illustrates a communications architecture used to establish communications between two telephones over the Internet.

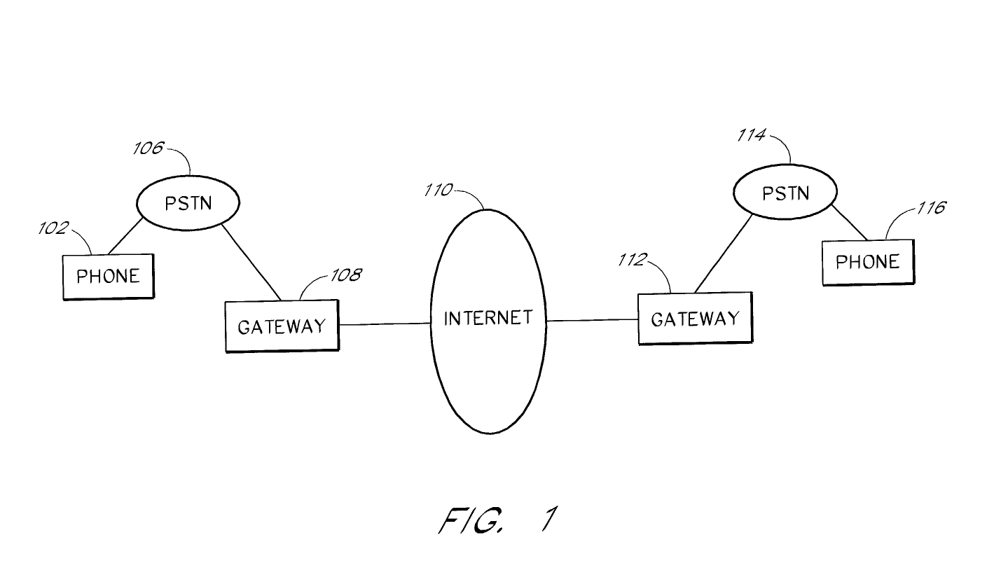

FIG. 2 is a block diagram illustrating a call routing architecture which may be used in accordance with one embodiment of the present invention.

FIG. 3 is a block diagram of an Internet phone call routing system in accordance with one embodiment of the present invention.

FIG. 4 is a more detailed block diagram illustrating the Internet Call routing system shown in FIG. 3.

### DETAILED DESCRIPTION OF THE PREFERRED EMBODIMENT

The present invention is directed to systems and methods for efficiently providing an integrated call routing system. As discussed in greater detail below, the integrated call routing system advantageously provides voice tuning for phone-to-phone, phone-to-computer, computer-to-phone, and computer-to-computer Internet voice calls. While the examples described below refer to the Internet and related protocols, such as TCP, the invention is not so limited and can be used with other packet-based local area and wide area networks. Further, while in many of the examples below H.323 terminals are illustrated, other types of terminals may be used as well, such as SIP compliant terminals or the like that are not fixed to a specific switch at a central switching location. In addition, while the examples provided below include modules implemented as software executing on computer systems, in other embodiments, the module functions can be implemented in hardware, such as in circuit boards, custom integrated circuits, gate arrays, and/or discrete circuitry.

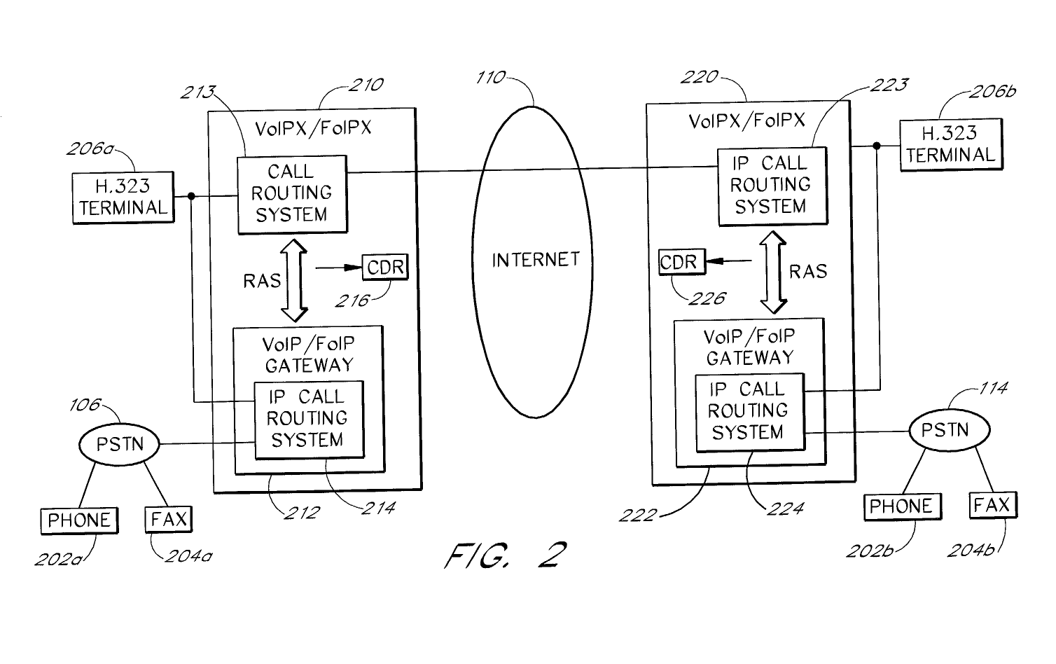

FIG. 2 illustrates an overview of an example system which may be used with the present invention. Referring to FIG. 2, a phone (TEL) 202a and a facsimile (FAX) 204a are connected to a first PSTN 106. The term “phone,” “telephone,” or “conventional phone,” as used herein, refers to traditional phones, such as those that are intended to be fixed to a specific switch at a central switching location. The term “Internet phone” or “computer voice terminal,” as used herein, refers to voice telecommunication devices that are not intended to be fixed to a specific switch at a central switching location, and often contain processors that provide intelligence and enable them to be independent from a central switching location. The first PSTN 106 is connected to the Internet 110 by a first voice/fax Internet switching device (VoIPX/FoIPX) 210. The first VoIPX/FoIPX 210 includes a first Call Routing System 213 and a first VoIP/FoIP Gateway 212. The first VoIP/FoIP Gateway 212 includes a first Internet Phone Call Routing System 214. Likewise, a second VoIPX/FoIPX Voice/Fax Internet Switching Device (VoIPX/FoIPX) 220 includes a second Call Routing System 223 and a second VoIP/FoIP Gateway 222. The second VoIP/FoIP Gateway 222 includes a second Internet Phone Call Routing System 224. A second PSTN 114 is connected the Internet 110 by the second VoIPX/FoIPX 220. Also, computer voice terminal, in this example, an H.323 terminal 206a is connected to the first VoIPX/FoIPX 210, and another computer voice terminal, in this example, an H.323 terminal 206b is connected to the second VoIPX/FoIPX 220. A phone (TEL) 202b and a FAX 204b are connected to the second PSTN 114.

As illustrated in FIG. 2, the Internet Phone Call Routing system 214 is layered above the VoIP/FoIP Gateway 212 in the first VoIPX/FoIPX 210. The Internet Phone Call Routing System 224 is layered above the VoIP/FoIP gateway 222 in the second VoIPX/FoIPX 220. Call Routing System 213 (“Gatekeeper 213”) is a proprietary gatekeeper performing typical gatekeeper functions such as H.225 registration, including performing the admission and status (RAS) procedure between the Gatekeeper 213 and the VoIP/FoIP gateway 212. Likewise, the Call Routing System 223 (“Gatekeeper 223”) is also a proprietary gatekeeper performing H.225 RAS between the Call routing system 223 and the VoIP/FoIP gateway 222. Also, call detailed records (CDRs) 216 and 226, used to keep track of call-related data for billing purposes, are recorded and/or stored in the first VoIPX/FoIPX 210 and the second VoIPX/FoIPX 220, respectively.

An example call setup procedure for a call being placed by a conventional phone or facsimile machine is typically established as follows. First, the phone 202a or FAX 204a is connected to the first VoIP/FoIP Gateway 212 via the first PSTN 106. When the phone number of a called party is transferred to the first VoIP/FoIP Gateway 212, the first Internet Phone Call Routing System 214 performs routing to the second Internet Phone Call Routing System 224 of the second VoIP/FoIP Gateway 222 located nearest or closer to the called party. More specifically, the first Internet Phone Call Routing System 214 exchanges information with the second Internet Phone Call Routing System 224 to determine a call routing path. Then, a path between the first VoIP/FoIP Gateway 212 and the second VoIP/FoIP Gateway 222 is established through the Internet 110. The second VoIP/FoIP Gateway 222 requests a call connection to the second PSTN 114 based on the received phone number of the called party. Accordingly, the second PSTN 114 transfers an alert, such as a ring signal, to the called party's receiving device, in this example, the phone 202b, and establishes the connection between the calling party and the called party.

An example call setup procedure for a call being placed by an H.323 terminal is typically established as follows. H.323 terminals 206a and 206b, illustrated in FIG. 2, are in compliance with the ITU-T (International Telecommunication Union-Telecommunication standardization sector) recommendation H.323, for multi-media conferencing systems, including communicating audio, video and data on a LAN (Local Area Networks), which provide a non-guaranteed quality of service. A H.323 system can include terminals, gateways, gatekeepers, an MCU (Multipoint Control Unit) and so on. The H.323 terminals, which provide real-time bi-directional communication, can be used to communicate voice, video and/or other types of data. An H.323 based Internet phone sets up a call in accordance with a Q.931 signaling procedure using Transmission Control Protocol (TCP). When the call is setup, an H.245 control channel is allocated to negotiate the channel capability. Then, a logical channel for data transmission is allocated in accordance with the compensated channel capability and then audio and/or video communication is performed using protocols of RTP/RTCP/UDP (Real-time Transport Protocol/Real-time Transport Control Protocol/User Datagram Protocol). Other types of data communication make use of the TCP protocol.

H.323 terminals often serve as the end points for voice transmission. H.323 terminals can be, by way of example, a PC or a stand-alone device running H.323 standard protocol and optionally multimedia applications having a microphone and a speaker correspondingly used to receive and reproduce voice or other audio sounds. A common example of an H.323 terminal is a PC running Microsoft NetMeeting software and an Ethernet-enabled phone. As previously discussed, H.323 terminals typically support real-time, two-way communications with other H.323 entities. H.323 terminals implement voice transmission functions and generally include at least one voice codec that sends and receives packetized voice. Of course other standards or protocols may be used as well.

A gateway connects two dissimilar networks. An H.323 gateway provides connectivity between an H.323 network and a non-H.323 network. For example, a gateway can connect and provide communication between an H.323 terminal and PSTN networks. This connectivity of dissimilar networks is achieved by translating protocols for call setup and release, converting media formats between different networks, and transferring information between the networks connected by the gateway. A gateway is not generally needed for communication between two terminals on an H.323 network.

A gatekeeper performs intelligent processing within the H.323 network. Often, the gatekeeper is the focal point for calls within the H.323 network. Although gatekeepers may not be required, if present in a network, gatekeepers provide important services such as addressing, authorization and authentication of terminals and gateways; bandwidth management; accounting; billing; and/or charging. Gatekeepers may also provide call-routing services.

Multipoint Control Units (MCUs) provide support for conferences of three or more H.323 terminals. Terminals participating in the conference establish a connection with the MCU. The MCU manages conference resources, negotiates between terminals for the purpose of determining the audio or video codec to use, and may handle the media stream.

The gateways, gatekeepers, and MCUs are logically separate components within the H.323 standard but can be implemented as a single physical device.

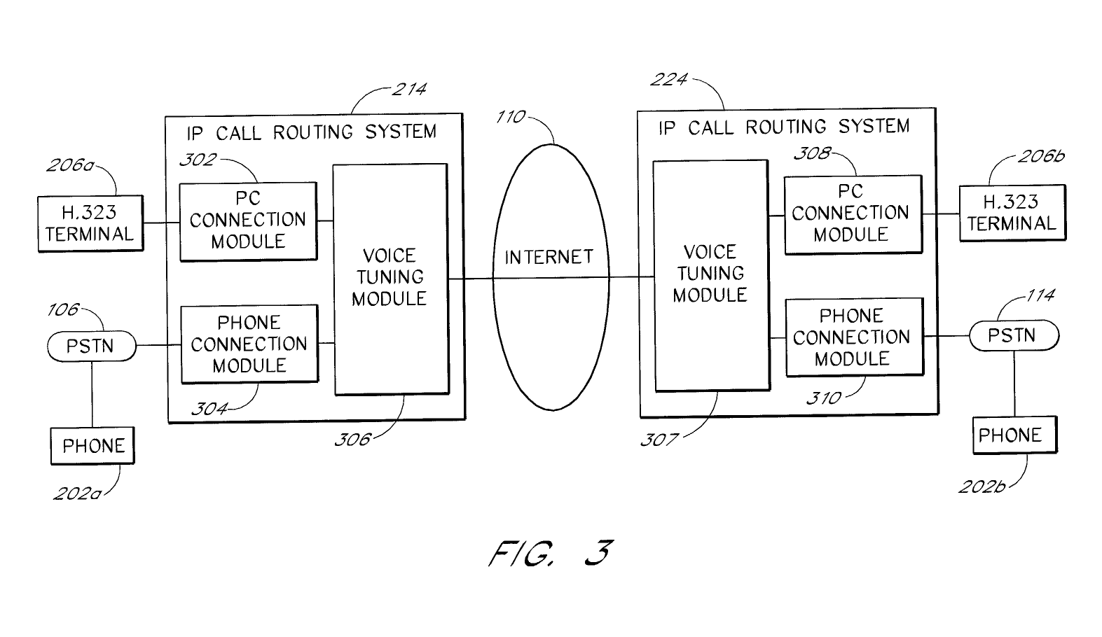

FIG. 3 illustrates an example Internet phone call routing system according to one embodiment of the present invention, showing the IP Call Routing System 214, the IP Call Routing System 224 in greater detail. Each call routing system may include software modules executing on one or more general purpose computers or computer server systems, and may further include telephony interface cards, such as T1 or E1 interface cards. The general purpose computers or computer server systems typically utilize operating systems, such as, by way of example, Microsoft® Windows® 3.1, Microsoft® Windows® 95, Microsoft® Windows® 98, Microsoft® Windows® NT, Microsoft® Windows(2000, Microsoft® Windows® Me, Sun™ Solaris™, Unix, Red Hat® Linux, or others. As shown in FIG. 3, the Internet Phone Call Routing System (214 or 224 of FIG. 2) includes a PC (H.323) Connection Module, Phone Connection Module, and a Voice Tuning Module.

The first Internet Phone Call Routing System 214 includes a first PC Connection Module 302 for connection with H.323 terminals, such as first H.323 terminal 206a, a first Phone Connection Module 304 for connection with conventional phones, such as a first phone 202a, and a Voice Tuning Module 306. The Voice Tuning Module 306 is connected to both the Phone Connection Module 302 and the PC Connection Module 302. Likewise, the second Internet Phone Call Routing System 224 includes a second PC Connection Module 308 for connection with H.323 terminals, such as second H.323 terminal 206b, a second Phone Connection Module 310 for connection with conventional phones, such as second phone 202b, and a Voice Tuning Module 307. The Voice Tuning Module 307 is connected to both the Phone Connection Module 310 and the PC Connection Module 308. Generally, because facsimile machines comply with the T.38 protocol, there is no need for voice tuning by the Voice Tuning Modules, 306, 307 for facsimile calls.

The two Internet Phone Call Routing Systems 214 and 224 are connected via the Internet. The Internet Phone Call Routing Systems 214 and 224 selectively perform appropriate voice tuning depending on the connection case i.e. computer-to-computer, computer-to-phone, phone-to-computer and phone-to-phone. Appropriate voice tuning can be performed by either of the Internet Phone Call Routing Systems 214 or 224 to facilitate bi-directional communication. In other words, either side can initiate the call and perform voice tuning for the operative connection case. For example, any of the devices 206a, 206b, 202a or 202b can initiate a call. The voice tuning is performed by the Internet Phone Call Routing System connected to the terminal initiating the call. In one embodiment, once the voice tuning is performed and the connection is established, no additional voice tuning is performed, though in other embodiments, voice tuning may be dynamically performed.

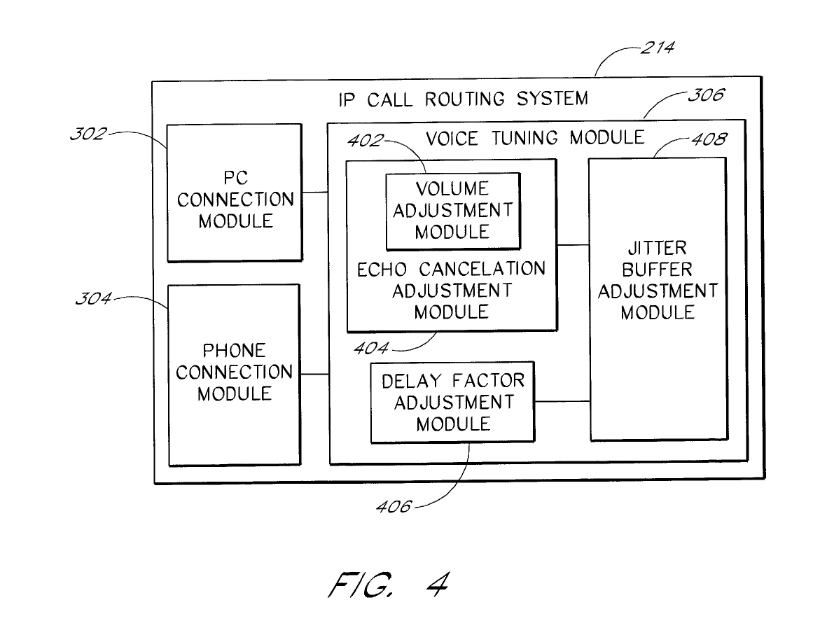

FIG. 4 illustrates the Voice Tuning Module 306 in greater detail. The Voice Tuning Module 307, includes the same modules as the Voice Tuning Module 306. As illustrated in FIG. 4, the Voice Tuning Module 306 includes a Volume Adjustment Module 402, an Echo Cancellation Adjustment Module 404, a Delay Factor Adjustment Module 406, and a Jitter Buffer Adjustment Module 408.

The Echo Cancellation Adjustment Module 404 is used to minimize or reduce any echo present in the connection. Because echo is affected by volume, the Echo Cancellation Adjustment Module 404 includes a Volume Adjustment Module 402 which provides volume adjustments. The Volume Adjustment Module 402 first adjusts the volume to a user-friendly level and the Echo Cancellation Adjustment Module 402 thereafter checks and adjusts the echo cancellation parameter reduce or minimize the echo.

The Delay Factor Adjustment Module 406 is used to reduce or minimize delay in data transmission. Delay is affected by the speed of the transmission, and so the Delay Factor Adjustment Module 406 checks the current bandwidth or speed of the connection and adjusts the packet size and frame to minimize delay.

The Jitter Buffer Adjustment Module 408 acts to further reduce data transmission delays. Because voice data is sent in a packet form, the voice packets may not arrive in the proper order. The Jitter Buffer Adjustment Module 408 compensates for the voice packets that are delayed by automatically adjusting the length of the jitter buffer.

Advantageously, the Internet Phone Call Routing System 214 performs voice tuning for the four types of connection cases by making a distinction between an inbound call and an outbound call and adjusting the values of the three parameters, namely, echo, delay, and jitter buffer to provide proper voice tuning and to enable automatic routing of the calls regardless of the connection case. The Internet Phone Call Routing System 214 first determines which connection case is operative, that is, which connection case a given call falls into, and then performs appropriate voice tuning.

The Internet Phone Call Routing System 214 determines which connection case is operative by examining the mode of the calling terminal and the mode of the called terminal. These two modes determine the connection case. For example, if both the calling terminal and the called terminal are phones, both modes are set to phone thereby establishing a phone-to-phone connection case. If, instead, the calling terminal is a phone and the called terminal is a computer or other H.323 device, the first mode is set to phone and the second mode is set to computer thereby establishing a phone-to-computer connection case. If the calling terminal is a computer or other H.323 device and the called terminal is a phone, the first mode is set to computer and the second mode is set to phone, thereby establishing a computer-to-phone connection case. If the calling terminal is a computer or other H.323 device and the called terminal is a computer or other H.323 device, the first mode is set to computer and the second mode is set to computer, thereby establishing a computer-to-computer connection case.

The operation of one embodiment of the Internet Phone Call Routing System will now be described for each of the four connection types.

1. Phone-To-Phone Connection

Referring to FIGS. 2 and 3, a user makes a call using the phone 202a to connect to the VoIP/FoIP Gateway 212 via the PSTN 106. Because the calling terminal is a phone, it will connect to the Phone Connection Module 304 in the Internet Phone Call Routing System 214 of the VoIP/FoIP Gateway 212. By connecting to the Phone Connection Module 304, the calling terminal signifies that it is a phone, and so the first mode of the connection case is therefore set to phone.

The second mode of the connection case is set by examining the destination information provided to the VoIPX/FoIPX 210. When the PSTN 106 connects to the VoIPX/FoIPX 210, it provides destination information to the VoIPX/FoIPX 210. Destination information, which in this case includes a telephone number, is provided by the PSTN 106 to the VoIPX/FoIPX 210 and is thus available to VoIPX/FoIPX components, including the Gatekeeper 213 and the VoIP/FoIP Gateway 212, which use the destination information to perform various functions. The Gatekeeper 213 receives and translates the destination information to set the mode of the called terminal. The Gatekeeper 213 recognizes the format of each type of destination information it receives and determines what type of terminal is being called. For example, the destination information may be an IP address, a user ID, or a telephone number. In this case, the destination information includes a phone number. The Gatekeeper 213 recognizes that the called terminal is a phone and sets the second mode to phone. The connection case is thus determined to be a phone-to-phone case.

Once the operative connection case is so determined, the Voice Tuning Module 306 and its various modules adjust the echo, delay, jitter buffer parameters appropriately to complete the voice tuning operation for a phone-to-phone call-type.

2. Phone-To-Computer Connection

Referring to FIGS. 2 and 3, a user makes a call using the phone 202a to connect to the VoIP/FoIP Gateway 212 via the PSTN 106. Because the calling terminal is a phone, it connects to the Phone Connection Module 304 in the Internet Phone Call Routing System 214 of the VoIP/FoIP Gateway 212. As in the phone-to-phone connection case, by connecting to the Phone Connection Module 304, the calling terminal signifies that it is a phone. The first mode to the connection case is therefore set to phone.

The second mode to the connection case is set by looking at the destination information that is provided to the VoIPX/FoIPX 210. When the PSTN 106 connects to the VoIPX/FoIPX 210, it provides destination information to the VoIPX/FoIPX. The Gatekeeper 213 receives and translates the destination information to set the mode of the called terminal. As stated above, the Gatekeeper 213 recognizes the format of each type of destination information it receives and determines what type of terminal is being called. In this connection case, the destination information includes a phone number or a user ID. The user ID in this case can be selected from a user directory or a numeric user ID can be entered using a touch-tone phone if the caller knows the called terminal's user ID.

In the case where the destination information includes a telephone number, the Gatekeeper 213 can translate the telephone number to an IP address and set the mode of the called terminal to computer. The Gatekeeper 213 performs this translation of the phone number to an IP address by referring a user database that can reside either in the Gatekeeper 213 itself or in the VoIP/FoIP Gateway 212. The user database can contain information that facilitates translation among various types of destination information. By referring to the user database, the Gatekeeper 213 recognizes that the phone number is pre-assigned to a computer. The Gatekeeper thus provides the appropriate IP address of the called terminal and sets the called terminal mode to computer. The connection case is thus determined to be a phone-to-computer case.

In the case where the destination information is a user ID, the caller selects the user ID from a user directory or the caller can enter the user ID directly using the touch-tone phone. If the caller does not know the user ID, the caller can select a user ID from a user directory that is audibly provided to the caller over the phone and making a selection therefrom. The user directory is stored in the user database either in the Gatekeeper 213 itself or in the VoIP/FoIP Gateway 212. The Gatekeeper 213 receives the user ID and performs the necessary translation of the provided user ID and recognizes that the called terminal is a computer. The Gatekeeper 213 thereby provides the IP address of the called terminal and sets the second mode to computer. The connection case is thus determined to be a phone-to-computer case.

As in the previous case, once the operative connection case is so determined, the Voice Tuning Module 306 adjusts the echo, delay, jitter buffer parameters appropriately to complete the voice tuning operation for a phone-to-computer call-type.

3. Computer-To-Phone Connection

Referring to FIGS. 2 and 3, a user makes a call using the H.323 terminal 206a, which may be a personal computer, to connect to the VoIP/FoIP Gateway 212. Because the calling terminal is an H.323 terminal, it connects to the PC Connection Module 302 in the Internet Phone Call Routing System 214 of the VoIP/FoIP Gateway 212. As in the other connection cases discussed above, by connecting to the PC Connection Module 302, the calling terminal signifies that it is a computer or other H.323 terminal. The first mode of the connection case is therefore set to computer.

The second mode of the connection case is set in the same manner as the previous connections cases. The second mode is set by examining the destination information that is provided to the VoIPX/FoIPX 210. When the H.323 terminal 206a connects to the VoIPX/FoIPX 210, it provides destination information to the VoIPX/FoIPX. The destination information, a telephone number in this case, is provided to the VoIPX/FoIPX and is available for the Gatekeeper 213. The Gatekeeper 213 recognizes that a telephone number indicates that the called terminal is a phone. Therefore, the Gatekeeper 213 recognizes that the called terminal is a phone and sets the second mode to phone. The connection case is thus determined to be a computer-to-phone case.

As before, once the operative connection case is so determined, the Voice Tuning Module 306 adjusts the echo, delay, jitter buffer parameters appropriately to complete the voice tuning operation for a computer-to-phone call-type.

4. Computer-to-Computer Connection

In this connection case, an H.323 terminal 206a connects to the VoIPX/FoIPX 210 via the Internet phone call routing system 214. A connection is established in this case by accessing a user database which can reside in the Gatekeeper 213 or in the VoIP/FoIP Gateway 212, but normally in the Gatekeeper 213. As indicated before, the user database contains, by way of example, user information such as name, address, IP address, phone number, and user ID that can facilitate translation among these types of information. Here, the user information is used to establish a peer-to-peer connection between the H.323 Terminal 206a and the H.323 Terminal 206b.

H.323 Terminal 206a first sends destination information such as destination user ID, IP address or phone number that is pre-assigned to the destination H.323 Terminal 206b to the Gatekeeper 213. The Gatekeeper 213 will translate the destination information to IP address if not in the form of an IP address already and send it to VoIP/FoIP Gateway 212 along with calling party's IP address. The Voice Tuning Module will then determine the values of the three parameters, echo, delay, and jitter buffer recognizing that the connection type is a computer-to-computer case. Upon setting the values of the three parameters, VoIP/FoIP Gateway will forward this information to the Gatekeeper 213. The Gatekeeper 213 will then send this information back to H.323 terminal 206a. The H.323 terminal 206a can now make a peer-to-peer connection with the H.323 terminal 206b.

Because the Gatekeeper 213 knows the destination of the call and the type of the called terminal by examining the user information, it will provide a direct connection to the destination H.323 terminal 206b by instructing the VoIP/FoIP Gateway 212 to analyze the actual available bandwidth using the three parameters, namely echo, delay, and jitter buffer, from the Voice Tuning Module 306. Thus, the voice tuning is appropriately selected for a computer-to-computer call-type.

As described above, the Internet phone call routing system according to the present invention determines the features of terminals of a calling party and a called party, and automatically performs voice tuning, in accordance with Table 1 below, thereby quickly and efficiently processing calls corresponding to any of the four connection call cases.

TABLE 1

| Calling Party Device | Called Party Device | Voice Tuning Type |
|---|---|---|
| Phone | Phone | Phone-phone |
| Phone | Computer | Phone-Computer |
| Computer | Phone | Computer-phone |
| Computer | Computer | Computer-to-Computer |

As shown in Table 1, if the device of a calling party is a phone and the device of a called party is also a phone, voice tuning is set to the phone-phone mode. If the device of a calling party is a phone and the device of a called party is a computer, voice tuning is set to the phone-computer mode. If the device of a calling party is a computer and the device of a called party is a phone, voice tuning is set to the computer-phone mode. If the device of a calling party is a computer and the device of a called party is also a computer, voice tuning is set to the computer-to-computer mode.

As described above, unlike conventional call routing systems, in which four independent systems are needed for the four types of call connection, the present invention provides an integrated call routing system, which automatically provides appropriate voice tuning for phone-to-phone, phone-to-computer, computer-to-phone, and computer-to-computer voice calls, thereby reducing system costs.

Although this invention has been described in terms of certain preferred embodiments, other embodiments that are apparent to those of ordinary skill in the art are also within the scope of this invention. Accordingly, the scope of the present invention is intended to be defined only by reference to the appended claims.

What is claimed is:

1. An integrated call routing system used to perform voice tuning on calls, comprising:
a first computer connection module used to receive calls placed using an Internet voice terminal;
a first phone connection module used to receive calls placed by a first phone unit intended to be fixed to a specific switch at a central switching location; and
at least a first voice tuning module configured to automatically perform a first type of voice tuning for calls received by the first computer connection module whose destination information indicates that the destination is a phone unit, wherein the voice tuning module is configured to automatically perform a second type of voice tuning for calls received by the first computer connection module whose destination information indicates that the destination is another Internet voice terminal, wherein the voice tuning module is configured to automatically perform a third type of voice tuning for calls received by the first phone connection module whose destination information indicates that the destination is a phone unit, and wherein the voice tuning module is configured to automatically perform a fourth type of voice tuning for calls received by the first phone connection module whose destination information indicates that the destination is an Internet voice terminal.

2. The integrated call routing system as defined in claim 1, wherein the Internet voice terminal is an H.323 terminal, including a computer having a microphone and a speaker.

3. The integrated call routing system as defined in claim 1, wherein the voice tuning module performs at least echo cancellation and packet size adjustment.

4. The integrated call routing system as defined in claim 1, wherein the voice tuning module performs at least volume adjustment and jitter buffer adjustment.

5. The integrated call routing system as defined in claim 1, wherein the call routing system is included in a Voice over Internet Protocol (VoIP) gateway.

6. The integrated call routing system as defined in claim 1, wherein the integrated routing system is configured to route call packets over the Internet.

7. The integrated call routing system as defined in claim 1, wherein the integrated routing system is coupled to a Public Switched Telephone Network (PSTN) to receive calls from phone units.

8. A method of performing voice tuning for calls placed over a telephony network, comprising:
receiving call information for a call, the call information including destination information, from a first terminal;
determining what type of terminal the first terminal is;
examining the destination information to determine if the destination terminal is a phone or an Internet voice terminal;
performing computer-to-computer voice tuning for the call at least partly in response to determining that the first terminal is an Internet voice terminal and that the destination terminal is an Internet voice terminal;
performing phone-to-computer voice tuning for the call at least partly in response to determining that the first terminal is a phone and that the destination terminal is an Internet voice terminal;
performing computer-to-phone voice tuning for the call at least partly in response to determining that the first terminal is an Internet voice terminal and that the destination terminal is a phone; and
performing phone-to-phone voice tuning for the call at least partly in response to determining that the first terminal is a phone and that the destination terminal is a phone.

9. The method as defined in claim 8, further comprising connecting the call to the destination terminal via the Internet.

10. The method as defined in claim 8, further comprising receiving a second call from a second phone via a Public Switched Telephone Network (PSTN).

11. The method as defined in claim 8, further comprising receiving a second call from a second phone using a Voice over Internet Protocol (VoIP) gateway phone connection module.

12. The method as defined in claim 8, further comprising receiving a second call from a second Internet voice terminal using a Voice over Internet Protocol (VoIP) gateway computer connection module.

13. The method as defined in claim 8, wherein the voice tuning further comprises adjusting a volume of the call.

14. The method as defined in claim 8, wherein the voice tuning further comprises performing echo cancellation on the call.

15. The method as defined in claim 8, wherein the voice tuning further comprises adjusting a jitter buffer.

16. The method as defined in claim 8, wherein the voice tuning further comprises adjusting a packet size of a call packet.

17. An integrated IP call routing system comprising:
means for connecting a computer terminal of a calling party;
means for connecting a phone terminal of the calling party;
means for connecting a computer terminal of a called party;
means for connecting a phone terminal of the called party; and
voice tuning means for setting voice tuning to a phone-phone mode if the terminal of the calling party is a phone and the terminal of the called party is also a phone, to a computer-phone mode if the terminal of the calling party is a computer and the terminal of the called party is a phone, to a phone-computer mode if the terminal of the calling party is a phone and the terminal of the called party is a computer, and to a computer-computer mode if the terminal of the calling party is a computer and the terminal of the called party is also a computer.
